(19) United States
(12) Patent Application Publication
(10) Pub. No.: US 2016/0175786 A1
(43) Pub. Date: Jun. 23, 2016

(54) GAS MIXER

(71) Applicant: KAWASAKI JUKOGYO KABUSHIKI KAISHA, Kobe-shi (JP)

(72) Inventors: Kunio OKADA, Kakogawa-shi (JP); Atsushi HORIKAWA, Akashi-shi (JP)

(73) Assignee: KAWASAKI JUKOGYO KABUSHIKI KAISHA, Kobe-shi (JP)

(21) Appl. No.: 15/054,297

(22) Filed: Feb. 26, 2016

Related U.S. Application Data
(63) Continuation of application No. PCT/JP2014/068225, filed on Jul. 8, 2014.

(30) Foreign Application Priority Data
Oct. 11, 2013 (JP) 2013-213448

(51) Int. Cl. B01F 5/04; B01F 3/02

(52) U.S. Cl. CPC B01F 5/0476; B01F 3/026

(57) ABSTRACT

A gas mixer includes: an inner pipe through which a first gas passes; an outer pipe covering an outer periphery of the inner pipe to form a storage space between the inner pipe and the outer pipe; a supply pipe to supply a second gas to the storage space; and a guide pipe disposed in an interior of the inner pipe and through which at least the first gas passes, and the inner pipe is formed with first introduction holes to introduce the second gas stored in the storage space into a guide space defined between the guide pipe and the inner pipe. With the gas mixer, distributions of concentration, temperature, and flow speed can be made uniform, pressure loss can be low, and high mixing performance can be maintained even with variation of the flow rate or flow speed of gases to be mixed.

### CROSS REFERENCE TO THE RELATED APPLICATION

This application is a continuation application, under 35 U.S.C. §111(a), of international application No. PCT/JP2014/068225, filed Jul. 8, 2014, which claims priority to Japanese patent application No. 2013-213448, filed Oct. 11, 2013, the disclosure of which are incorporated by reference in their entirety into this application.

### BACKGROUND OF THE INVENTION

1. Field of the Invention

The present invention relates to a gas mixer which mixes flows of two gases different from each other in at least one of, for example, concentration, temperature, flow speed, and the like, such that a uniform distribution is obtained.

2. Description of Related Art

In a mixer which mixes a plurality of gases, a temperature distribution, a gas concentration distribution, and a flow speed distribution are desired to be uniform after the gases are mied. This is because, for example, if the temperature distribution of a mixed gas is not uniform, a problem arises that the service life of the mixer is shortened or the efficiency of the mixer is decreased due to stress generated by nonuniform thermal strain in devices disposed at the downstream side of the mixer. Conventionally, a mixer has been proposed in which a contraction flow portion having a reduced pipe diameter is provided in a passage pipe through which a first gas flows, and a second gas is mixed with the first gas that is accelerated by the contraction flow portion, whereby mixing in a deceleration flow downstream of the contraction flow portion can be enhanced to make a concentration distribution and a flow speed distribution uniform (see Patent Document 1). In addition, as another conventional mixer, a mixer has been known which has a structure in which a dispersion plate is disposed within a passage through which a first gas flows, and a second gas is caused to flow in from an oblique direction toward the dispersion plate to mix with the first gas (see Patent Document 2).

### RELATED DOCUMENT

### Patent Document

[Patent Document 1] JP Laid-open Patent Publication No. 2001-99407

[Patent Document 2] JP Laid-open Patent Publication No. 2012-72771

### SUMMARY OF THE INVENTION

However, the mixer in Patent Document 1 has great pressure loss since the contraction flow portion is provided therein. Meanwhile, the mixer in

Patent Document 2 has an advantage in having low pressure loss, but if a flow rate or flow speed of the second gas varies, the concentration distribution of the second gas with respect to the dispersion plate becomes nonuniform in accordance with the variation, so that high mixing performance cannot be maintained.

The present invention has been made in view of the above-described problems, and an object of the present invention is to provide a gas mixer which is able to make each of distributions of concentration, temperature, and flow speed uniform, which has low pressure loss, and which is able to maintain high mixing performance even with variation of the flow rate or flow speed of gases to be mixed.

In order to achieve the above-described object, a gas mixer according to the present invention includes: an inner pipe through which a first gas passes; an outer pipe covering an outer periphery of the inner pipe to form a storage space between the inner pipe and the outer pipe; a supply pipe to supply a second gas to the storage space; and a guide pipe disposed in an interior of the inner pipe and through which at least the first gas passes. The inner pipe is formed with a plurality of first introduction holes to introduce the second gas stored in the storage space to a guide space defined between the guide pipe and the inner pipe.

According to this gas mixer, since the second gas is supplied from the supply pipe to the storage space to be temporarily stored in the storage space, even when the flow rate or flow speed of the second gas flowing through the supply pipe varies, the pressure and the flow speed of the second gas are made uniform in the storage space. In addition, after the second gas is introduced from the storage space through the plurality of first introduction holes to the guide space between the inner pipe and the guide pipe through which the first gas flows, the second gas flows out from the guide space into the interior of the inner pipe to mix with the first gas flowing out from the guide pipe. At this time, the second gas flows out through an outlet (downstream end) extending over the entire periphery of the guide space, to the circumferential direction within the inner pipe at a uniform speed, so that uniform mixing of the second gas with the first gas within the inner pipe can be promoted. Furthermore, in the gas mixer, both first and second gases flowing through the interior of the inner pipe and through the guide space, respectively, in the same direction are mixed, so that pressure loss is low.

In the present invention, the inner pipe may have a passage area increasing toward a downstream side. Accordingly, after the first gas having flowed out from the guide space and the second gas having flowed out from the guide space mix with each other within the inner pipe, when the first and second gases flows through the interior of the inner pipe having the passage area increasing toward the downstream side, the first and second gases decelerate and spread, so that the mixing is further promoted.

In the present invention, the guide pipe may have an upstream end formed with an inflow port into which the first gas flows. Accordingly, the first gas flowing through the inner pipe flows along the flowing direction thereof directly into the inflow port at the upstream end of the guide pipe, so that pressure loss of the pipe is further reduced.

In the present invention, an inflow portion configured to allow the first gas to flow to the guide space may be formed between the inner pipe and an upstream end of the guide pipe, and the inner pipe may be formed with a plurality of second introduction holes to introduce the second gas into an interior of the guide pipe. Accordingly, the first gas having flowed through the inner pipe flows through the inflow portion into the guide space, and the second gas introduced from the storage space through the first introduction holes into the guide space is mixed with the first gas. Meanwhile, the second gas is introduced through the second introduction holes into the interior of the guide pipe and mixed with the first gas flowing through the guide pipe. Two mixed gases obtained by previously mixing the both gases in the guide space and the guide pipe, respectively, as described above are mixed at the downstream side of the inner pipe, so that each of distributions of concentration, temperature, and flow speed are made further uniform.

In the case where the second introduction holes to the guide pipe are formed, each of the second introduction holes may be formed in a nozzle and in the form of an elongated passage directed toward an inflow port of the guide pipe. Accordingly, the second introduction holes formed in the nozzles can cause the flow of the second gas to have directivity toward the inflow port of the guide pipe, so that the second gas can be assuredly introduced to the guide pipe in a required amount.

In the case where the inflow portion to the guide space is provided, the gas mixer may include a guide plate extending along a flow direction of the first gas and configured to support the guide pipe on the inner pipe. Accordingly, the guide pipe can be stably supported on the inner pipe through the guide plate. In addition, the first gas having flowed into the guide space through the inflow portion provided between the respective upstream ends of the inner pipe and the guide pipe smoothly flows since the guide plate extending along the flow direction of the first gas does not become great resistance, and thus an increase in pressure loss can be suppressed.

In the configuration in which the second introduction holes are formed, each of the first introduction holes may be formed in a nozzle and in the form of an elongated passage directed toward a downstream side in an inwardly oblique direction. Accordingly, the elongated first introduction holes can cause the flow of the second gas to have directivity toward the flow direction, so that the second gas can be introduced to the guide space in a required amount while an increase in pressure loss is suppressed.

In the present invention, a gap between an upstream end of the guide space and the inner pipe may be closed. Accordingly, the first gas is prevented from flowing into the guide space, and thus the flow of the second gas can be straightened in the guide space. Therefore, subsequent mixing of the second gas with the first gas is smoothly performed, so that a uniform speed distribution is obtained.

In the configuration in which the gap between an upstream end of the guide space and the inner pipe is closed, a downstream end of the guide space may have an opening area that allows the second gas to flow out at a speed close to a speed of the first gas. Accordingly, the first gas flowing out from the guide pipe and the second gas flowing out from the guide space can have a uniform flow speed distribution. In this case, variations of the flow speed relative to an average value is specifically reduced to be equal to or less than ±20%, and is further specifically reduced to be equal to or less than ±10%.

In the present invention, a baffle plate having multiple through-holes may be disposed at a downstream portion of the inner pipe. Accordingly, after both first and second gases flow to the downstream portion of the inner pipe in a mixed state, the first and second gases pass through the baffle plate and thereby are stirred, so that each of the distributions of concentration, temperature, and flow speed is made further uniform.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an arrangement and configuration diagram of a main configuration part of a gas turbine including a gas mixer according to a first embodiment of the present invention;

FIG. 2 is a longitudinal cross-sectional view of the gas mixer;

FIG. 3 is a left side view of FIG. 2;

FIG. 4 is a longitudinal cross-sectional view of a gas mixer according to a second embodiment of the present invention;

FIG. 5 is a left side view of FIG. 4; and

FIG. 6 is a front view showing a baffle plate in FIG. 4.

### DESCRIPTION OF EMBODIMENTS

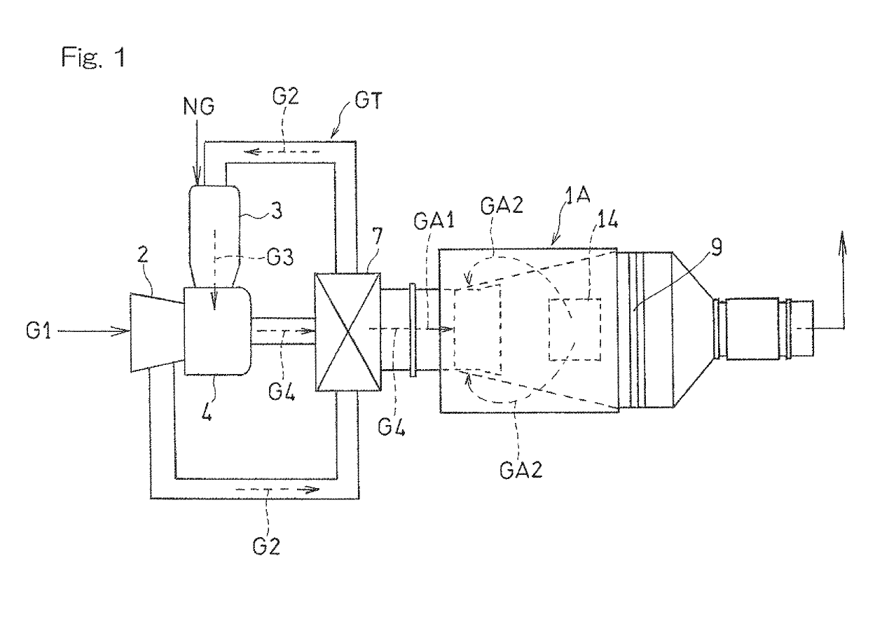

Hereinafter, embodiments of the present invention will be described in detail with reference to the drawings. A gas turbine GT shown in FIG. 1 includes a compressor 2, a combustor 3, and a turbine 4. As a low-calorie gas used in the gas turbine GT, a working gas G1 obtained by mixing air and fuel (a combustible component), such as ventilation air methane (VAM) generated from a coal mine or coal mine methane (CMM) having a higher combustible component (methane) concentration than the VAM, is compressed by the compressor 2 into a high-pressure compressed gas G2, and the compressed gas G2 is sent to the combustor 3. The compressed gas G2 is burnt in the combustor 3 together with natural gas NG supplied as main fuel to the combustor 3, to generate a high-temperature and high-pressure combustion gas G3, and the combustion gas G3 is supplied to the turbine 4 to drive the turbine 4.

The gas turbine GT further includes a regenerator (heat exchanger) 7 which heats the compressed gas G2 to be introduced from the compressor 2 to the combustor 3, with heat energy collected from an exhaust gas G4 of the turbine 4. The exhaust gas G4 discharged from the regenerator 7 is supplied as a first gas GA1 to a gas mixer 1A. In the gas mixer 1A, a second gas GA2 supplied through a supply pipe 14 is mixed with the first gas GA1. In the gas mixer 1A, the VAM is used as the second gas GA2 and contains less than 1% of methane gas. Both of the mixed first and second gases GA1 and GA2 are burnt by a catalyst 9 disposed at the downstream side and then discharged through a silencer (not shown) to the outside.

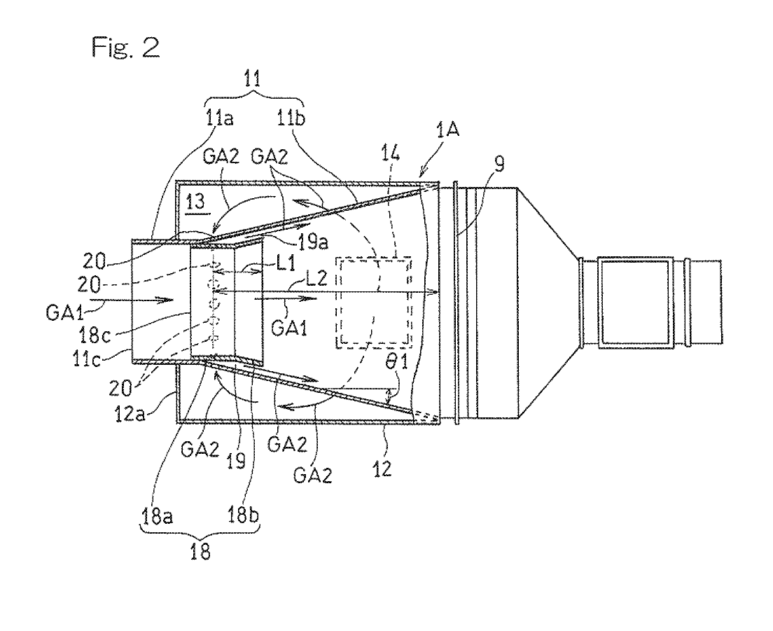

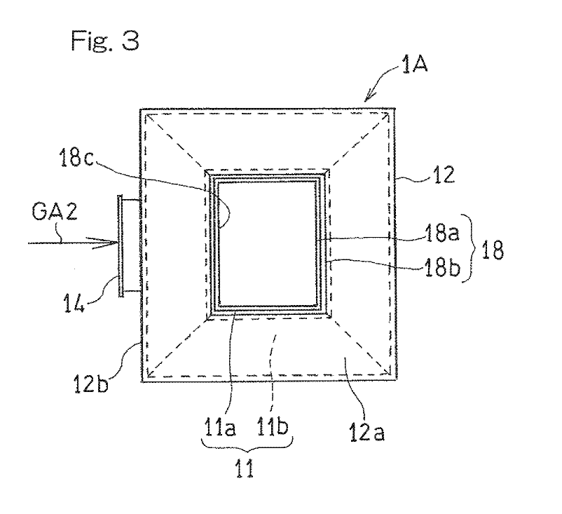

As shown in FIG. 2, the gas mixer 1A includes: an inner pipe 11 through which the first gas GA1 from the regenerator 7 passes; an outer pipe 12 which covers the entire outer periphery of the inner pipe 11 to form a storage space 13 defined between the inner pipe 11 and the outer pipe 12; the supply pipe 14 to supply the second gas GA2 to the storage space 13; and a guide pipe 18 which is disposed in the interior of the inner pipe 11 and through which only the first gas GA1 passes. As shown in FIG. 3, the outer pipe 12 has a bottomed prismatic tube shape with a bottom wall portion 12a at the near side of the drawing, and has a transverse cross-sectional shape which is a square. The supply pipe 14 is connected to one side wall portion 12b of the outer pipe 12, and the second gas GA2 is supplied through the supply pipe 14 into the storage space 13. Each of the inner pipe 11 and the guide pipe 18 has a tube shape having a transverse cross-sectional shape which is a square. As shown in FIG. 2, in the inner pipe 11 and the guide pipe 18, prismatic tube-shaped portions 11a and 18a at the upstream side are formed integrally with expanding tube portions 11b and 18b at the downstream side, respectively.

The prismatic tube-shaped portion 11a of the inner pipe 11 extends through the bottom wall portion 12a of the outer pipe 12 and is fixed to the bottom wall portion 12a in a gastight state, and the expanding tube portion 11b of the inner pipe 11 extends from a downstream end portion of the prismatic tube-shaped portion 11a in such a shape as to expand toward the downstream side. Therefore, the passage area (the cross-sectional area orthogonal to a flow direction) of the interior of the inner pipe 11 gradually increases toward the downstream side. The expanding tube portion 11b is expanded at a predetermined spreading taper angle θ1 (13° in this embodiment) relative to the axis of the prismatic tube-shaped portion 11a, and a downstream end portion which is a maximum area portion of the expanding tube portion 11b is set so as to have an outer peripheral surface having a square shape which has the substantially same dimension as the inner peripheral surface of the outer pipe 12. Thus, the outer peripheral surface of the downstream end portion of the inner pipe 11 is fitted into the inner peripheral surface of the outer pipe 12, so that the inner pipe 11 is supported also at the downstream end portion thereof on the outer pipe 12. The spreading taper angle θ1 of the expanding tube portion 11b may be in the range of about 8° to 18° and more specifically 10° to 15°.

The prismatic tube-shaped portion 18a of the guide pipe 18 has an outer peripheral surface which is fitted into the inner peripheral surface of the prismatic tube-shaped portion 11a of the inner pipe 11, and the expanding tube portion 18b extends from a downstream end portion of the prismatic tube-shaped portion 18a so as to expand toward the downstream side at a spreading taper angle which is substantially equal to that of the expanding tube portion 11b of the inner pipe 11. An upstream end portion of the prismatic tube-shaped portion 18a of the guide pipe 18 is joined to the downstream end portion of the prismatic tube-shaped portion 11a of the inner pipe 11 by means of welding in a state where the upstream end portion of the prismatic tube-shaped portion 18a is fitted into the downstream end portion of the prismatic tube-shaped portion 11a, so that the guide pipe 18 is supported on the inner pipe 11 in a cantilever form. Thus, an inflow port 18c opened in the upstream end of the guide pipe 18 is formed in a transverse cross-sectional shape which substantially coincides with the inner peripheral surface of the prismatic tube-shaped portion 11a of the inner pipe 11, so that the first gas GA1 supplied through an inflow port 11c of the inner pipe 11 to the prismatic tube-shaped portion 11a flows directly into the inflow port 18c.

A guide space 19 is formed over the entire periphery of the inner pipe 11 and between the expanding tube portion 18b of the guide pipe 18 supported on the inner pipe 11 with the above-described arrangement and the expanding tube portion 11b of the inner pipe 11. The guide space 19 extends in a direction along the inner peripheral surface of the expanding tube portion 11b of the inner pipe 11 which inner peripheral surface expands toward the downstream side. The gap between an upstream end of the guide space 19 and the inner pipe 11 is closed by joining of the prismatic tube-shaped portion 18a of the guide pipe 18 and the prismatic tube-shaped portion of the inner pipe 11 by means of welding as described above, and only the second gas GA2 in the storage space 13 is allowed to flow into the guide space 19 through first introduction holes 20 which will be described later. In addition, a downstream end 19a of the guide space 19 is set so as to have an opening area which allows the second gas GA2 flowing through the guide space 19 to flow out at a flow speed close to the flow speed of the first gas GA1 that flows through the inner pipe 11 during rated operation of the gas turbine GT. This setting is performed by selecting the guide pipe 18 having a required shape.

A plurality of first introduction holes 20 (twenty eight first introduction holes 20 in this embodiment) each in the form of a circular through-hole are formed at locations near the upstream end of the expanding tube portion 11b of the inner pipe 11. All of the first introduction holes 20 are circular holes having the same diameter, and are arranged at equal intervals over the entire periphery of the expanding tube portion 11b. The second gas GA2 stored in the storage space 13 is introduced through these first introduction holes 20 to the vicinity of the upstream end of the guide space 19.

In the gas mixer 1A, the first gas GA1 supplied to the prismatic tube-shaped portion 11a of the inner pipe 11 passes directly through the interior of the guide pipe 18 and then flows into the expanding tube portion 11b of the inner pipe 11. On the other hand, the second gas GA2 is supplied through the supply pipe 14 to the upstream side of the storage space 13 to be temporarily stored in the storage space 13, and is then introduced through multiple the first introduction holes 20 to the vicinity of the upstream end of the guide space 19 evenly over the entire periphery of the guide space 19. Furthermore, when the second gas GA2 flows out from the downstream end of the guide space 19, the second gas GA2 is mixed with the first gas GA1 that has flowed out from the guide pipe 18 into the expanding tube portion 11b of the inner pipe 11, such that the second gas GA2 envelops the entire periphery of the first gas GA1. Both gases GA1 and GA2 mixed thus pass through the downstream end portion of the inner pipe 11 and are burnt by the catalyst 9. Both gases GA1 and GA2 flow into the catalyst 9 with a uniform concentration distribution and a uniform flow speed distribution and are burnt by the catalyst 9, whereby an amount of NOx in the combustion gas is reduced.

In the gas mixer 1A, as clearly shown in FIG. 2, the second gas GA2 supplied through the supply pipe 14 to the storage space 13 is temporarily stored in the storage space 13. Accordingly, even when the flow rate or flow speed of the second gas GA2 flowing through the supply pipe 14 varies, since the pressure and the flow speed of the second gas GA2 are made uniform while the second gas GA2 is stored in the storage space 13, an adverse effect of the above variation of the flow rate or flow speed of the second gas GA2 on mixing performance can be eliminated. In addition, after the second gas GA2 is introduced from the storage space 13 through the plurality of first introduction holes 20 into the guide space 19 between the guide pipe 18, through which the first gas GA1 flows, and the inner pipe 11, when the second gas GA2 flows through the guide space 19 into the expanding tube portion 11b of the inner pipe 11, the second gas GA2 mixes with the first gas GA1 flowing out from the guide pipe 18.

In the gas mixer 1A, since, as the first introduction holes 20, multiple holes having the same diameter are formed at equal intervals over the entire periphery of the inner pipe 11, the second gas GA2 in the storage space 13 is introduced through the multiple first introduction holes 20 into the guide space 19 evenly over the entire periphery of the guide space 19, so that uniformization of the second gas GA2 in the guide space 19 can be enhanced. As a result, the second gas GA2 is evenly mixed with the first gas GA1 at the downstream side of the guide space 19. Furthermore, in the gas mixer 1A, the first and second gases GA1 and GA2 flowing through the guide pipe 18 and the guide space 19, respectively, toward the same direction are mixed, and thus the gas mixer 1A has an advantage in having low pressure loss.

A length L1 from the first introduction hole 20 to the downstream end of the guide pipe 18 may be about 20% to 30% of a length L2 from the first introduction hole 20 to the downstream end of the inner pipe 11, more specifically 22% to 26% of the length L2, and is 24% of the length L2 in this embodiment.

Since the inner pipe 11 has, at the downstream side, the expanding tube portion 11b which divergingly expands such that the passage area thereof increases toward the downstream side, the first gas GA1 having flowed out from the guide pipe 18 and the second gas GA2 having flowed out from the guide space 19 decelerate and spread in the expanding tube portion 11b in accordance with the passage area gradually increasing. Thus, mixing of both gases GA1 and GA2 is further promoted.

The upstream end of the guide pipe 18 is opened to form the inflow port 18c into which the first gas GA1 flows, and the upstream end portion of the guide pipe 18 is joined to the downstream end portion of the prismatic tube-shaped portion 11a of the inner pipe 11 by means of welding in a state where the upstream end portion of the guide pipe 18 is fitted into the downstream end portion of the prismatic tube-shaped portion 11a. Thus, the first gas GA1 supplied to the prismatic tube-shaped portion 11a of the inner pipe 11 flows along the flowing direction thereof directly into the inflow port 18c of the guide pipe 18, so that pressure loss of the pipe is further reduced.

Since the upstream end portion of the prismatic tube-shaped portion 18a of the guide pipe 18 is joined to the downstream end portion of the prismatic tube-shaped portion 11a of the inner pipe 11 by means of welding in a state where the upstream end portion of the guide pipe 18 is fitted into the downstream end portion of the prismatic tube-shaped portion 11a, the gap between the upstream end of the guide space 19 and the inner pipe 11 is closed. Accordingly, the first gas GA1 is prevented from flowing into the guide space 19. Thus, by selecting the guide pipe 18 having a required shape, and, for example, adjusting the shape of the guide space 19 as appropriate, the flow speed of the second gas GA2 flowing out from the guide space 19 can be set so as to be close to the flow speed of the first gas GA1 flowing out from the guide pipe 18, thereby obtaining a uniform speed distribution. In particular, the gas mixer 1A is suitable for mixing two gases GA1 and GA2 having gas concentrations (methane gas concentrations in this example) substantially equal to each other, such that a uniform speed distribution is obtained. According to an experiment, the speed distribution at the outlet of the inner pipe 11 is set such that a ratio of the flow speed relative to an average value may be within a range of 0.8 to 1.2, that is, is equal to or less than ±20%, and more specifically equal to or less than ±10%.

In the gas mixer 1A, the outer pipe 12, the inner pipe 11, and the guide pipe 18 are formed in a polygonal tube shape. However, even when these components are formed in a circular tube shape, the same advantageous effects as described above can be obtained. In addition, the catalyst 9 may be omitted.

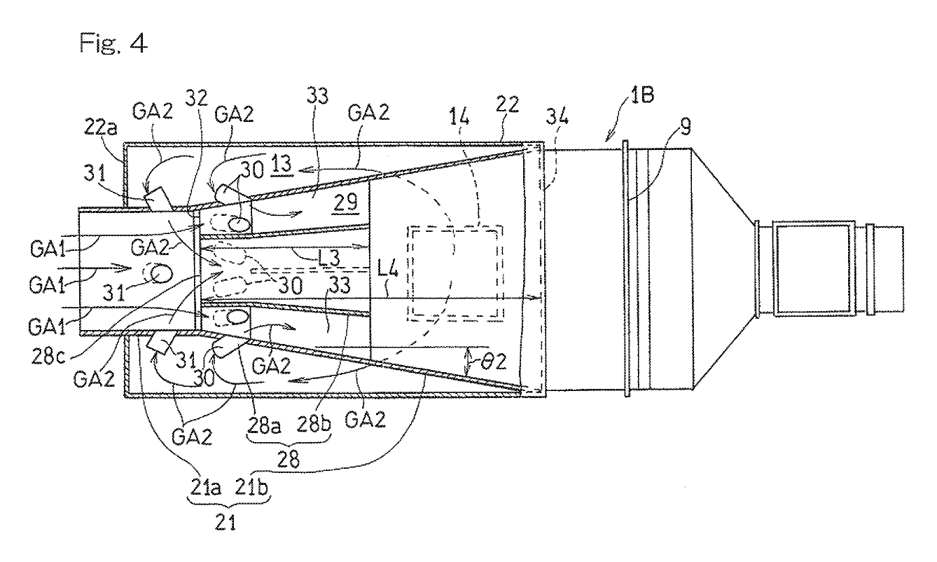

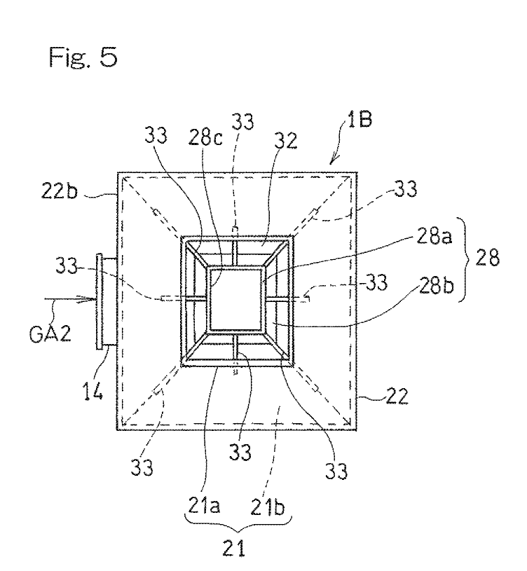

FIG. 4 is a longitudinal cross-sectional view showing a gas mixer 1B according to a second embodiment of the present invention. FIG. 5 is a left side view of FIG. 4. In these drawings, components that are identical or equivalent to those in FIGS. 2 and 3 are designated by the same reference numerals, and redundant description thereof is omitted. As shown in FIG. 4, in the gas mixer 1B, a prismatic tube-shaped portion 28a of a guide pipe 28 is formed in a transverse cross-sectional shape which is a square and is slightly smaller than that of a prismatic tube-shaped portion 21a of an inner pipe 21. Therefore, a guide space 29 formed between the inner pipe 21 and the guide pipe 28 is formed as a space having a larger opening area than the guide space 19 of the gas mixer 1A of the first embodiment, and an annular inflow portion 32 is formed between the upstream end of the guide space 29, that is, the upstream end of the guide pipe 28, and the inner pipe 21 such that the gap therebetween is not closed but opened. Thus, the first gas GA1 from the prismatic tube-shaped portion 21a of the inner pipe 21 flows into the guide pipe 28 through an inflow port 28c opened in the upstream end of the guide pipe 28, and also flows into the guide space 29 through the inflow portion 32. A spreading taper angle θ2 of an expanding tube portion 21b of the inner pipe 21 is set at 10° which is smaller than 13° in the first embodiment. The spreading taper angle θ2 may be about 6° to 14° and more specifically 8° to 12°.

The guide pipe 28 is supported on the inner pipe 21 through a plurality of guide plates 33 (eight guide plates 33 in this embodiment) disposed between the outer surface of the guide pipe 28 and the inner surface of the inner pipe 21. The respective guide plates 33 are disposed so as to be directed along the flow direction of both gases GA1 and GA2, and are arranged at equal intervals of 45° in a circumferential direction so as to extend radially from the guide pipe 28 toward the inner pipe 21 as viewed from the flow direction, as shown in FIG. 5. An inner end portion and an outer end portion of each guide plate 33 are fixed to the outer surface of the guide pipe 28 and the inner surface of the inner pipe 21, respectively, by means of welding. Since each guide plate 33 is disposed so as to be directed along the flow direction of both gases GA1 and GA2 as described above, each guide plate 33 does not become great resistance against the flow of the gases GA1 and GA2 flowing through the guide space 29, and the guide pipe 28 is firmly supported on the inner pipe 21 through the guide plates 33.

As shown in FIG. 4, a plurality of (e.g., sixteen) first introduction holes 30 through which the second gas GA2 in the storage space 13 is introduced to the guide space 29 are provided at locations at the upstream side of the expanding tube portion 21b of the inner pipe 21 and at equal intervals in the circumferential direction over the entire periphery of the expanding tube portion 21b. The first introduction holes 30 are formed in respective tubular nozzles fixed to the expanding tube portion 21b and having the same hole diameter, and each in the form of elongated passage directed toward the downstream side in an inwardly oblique direction relative to the guide space 29. In order to avoid each nozzle becoming resistance against the flow of the first gas GA1, an end portion of each nozzle does not project into the guide space 29.

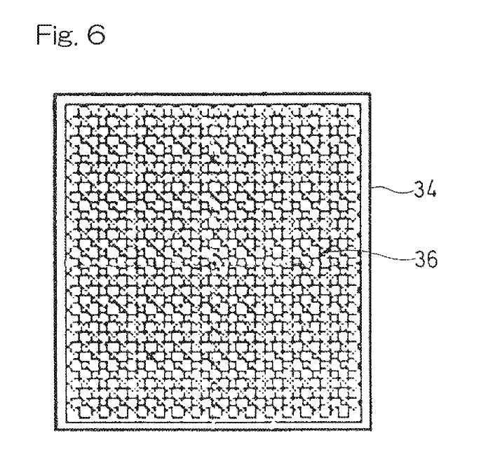

In the gas mixer 1B, further, a plurality of (e.g., four) second introduction holes 31 through which the second gas GA2 stored in the storage space 13 is introduced into the interior of the guide pipe 28 are formed at a downstream portion of the prismatic tube-shaped portion 21a of the inner pipe 21, that is, at locations, in the inner pipe 21, near the upstream side of the first introduction holes 30, and at equal intervals of 90° in the circumferential direction. These second introduction holes 31 are elongated passages which are formed in nozzles fixed to the prismatic tube-shaped portion 21a and having the same hole diameter and are directed toward the inflow port 28c of the guide pipe 28. End portions of these nozzles also do not project into the inner pipe 21. In addition, a baffle plate 34 is disposed at a downstream end portion of the expanding tube portion 21b of the inner pipe 21. The baffle plate 34 is composed of a perforated plate having multiple through-holes 36 as shown in FIG. 6.

In the gas mixer 1B, the first gas GA1 supplied to the prismatic tube-shaped portion 21a of the inner pipe 21 flows directly through the inflow port 28c into the guide pipe 28, passes through the guide pipe 28, and then flows into the expanding tube portion 21b of the inner pipe 21. In addition, the first gas GA1 supplied to the prismatic tube-shaped portion 21a of the inner pipe 21 also flows through the inflow portion 32 into the guide space 29, passes through the guide space 29, and flows into the expanding tube portion 21b. On the other hand, the second gas GA2 is supplied to the upstream side of the storage space 13 through the supply pipe 14 to be temporarily stored in the storage space 13, and then is introduced through the multiple first introduction holes 30 to the vicinity of the upstream end of the guide space 29 evenly over the entire periphery of the guide space 29. The second gas GA2 introduced to the guide space 29 flows out through the downstream end of the guide space 29 while being mixed with the first gas GA1 flowing through the guide space 29.

Also, the second gas GA2 having flowed from the storage space 13 through the second introduction holes 31 into the guide pipe 28 flows out through the downstream end of the guide pipe 28 while being mixed with the first gas GA1 flowing through the guide pipe 28. After both gases GA1 and GA2 mixed previously in each of the guide space 29 and the guide pipe 28 as described above flow out to the expanding tube portion 21b of the inner pipe 21 and are mixed therein, when the gases GA1 and GA2 flow to the downstream end of the inner pipe 21, the gases GA1 and GA2 are stirred by the baffle plate 34, and burnt by the catalyst 9.

In the gas mixer 1B, since the inflow portion 32 which allows the first gas GA1 to flow into the guide space 29 is formed between the inner pipe 21 and the upstream ends of the guide pipe 28 and the inner pipe 21 is formed with the plurality of second introduction holes 31 through which the second gas GA2 is introduced into the interior of the guide pipe 28, the first gas GA1 flowing through the inner pipe 21 flows through the inflow portion 32 into the guide space 29, and the second gas GA2 introduced from the storage space 13 through the first introduction holes 30 into the guide space 29 is mixed with the first gas GA1. On the other hand, the second gas GA2 is introduced also through the second introduction holes 31 into the interior of the guide pipe 28 and mixed with the first gas GA1 flowing through the guide pipe 28. Two mixed gases obtained by previously mixing both gases GA1 and GA2 in the guide space 29 and the guide pipe 28, respectively, as described above are mixed at the downstream side of the inner pipe 21, so that each of the distributions of concentration, temperature, and flow speed is made further uniform.

Since the second introduction holes 31 are composed of elongated passages which are formed in the nozzles and directed toward the inflow port 28c of the guide pipe 28, the second introduction holes 31 formed in the nozzles can cause the flow of the second gas GA2 to have directivity toward the inflow port 28c of the guide pipe 28, so that the second gas GA2 can be assuredly introduced to the guide pipe 28 in a required amount.

A length L3, in the flow direction, of the guide pipe 28 may be about 40% to 60% of a length L4 from the upstream end of the guide pipe 28 to the downstream end of the inner pipe 21, and more specifically 45% to 55% of the length L4, and is 50% of the length L4 in this embodiment.

Also, in the gas mixer 1B, since the guide plates 33 which extend along the flow direction of the first gas GA1 and support the guide pipe 28 on the inner pipe 21 are provided, the guide pipe 28 can be stably supported on the inner pipe 21 through the guide plates 33. In addition, the first gas GA1 having flowed into the guide space 29 through the inflow portion 32 provided between the respective upstream ends of the inner pipe 21 and the guide pipe 28 smoothly flows since each guide plate 33 extending along the flow direction of the first gas GA1 does not become great resistance, and thus an increase in pressure loss can be suppressed.

Since the first introduction holes 30 are formed as elongated passages which are formed in the nozzles and directed toward the downstream side in the inwardly oblique direction, the elongated first introduction holes 30 can cause the flow of the second gas GA2 to have directivity toward the flow direction. Therefore, the second gas GA2 can be introduced to the guide space 29 in a required amount while an increase in pressure loss is suppressed.

In the gas mixer 1B, since the baffle plate 34 having the large number of through-holes 36 as shown in FIG. 6 is disposed at the downstream portion of the inner pipe 21, after the first and second gases GA1 and GA2 shown in FIG. 4 flow to the downstream portion of the inner pipe 21 in a mixed state, the first and second gases GA1 and GA2 pass through the baffle plate 34 and thereby are stirred, so that each of the distributions of concentration, temperature, and flow speed is made further uniform.

In an experiment using the above-described mixers 1A and 1B of the first and second embodiments, even with practically-assumed maximum differences in concentration, temperature, and flow speed between the first and second gases GA1 and GA2, it was confirmed that, at the mixer outlet, each of the concentration and temperature distributions becomes equal to or less than ±10% of an average value and the flow speed distribution becomes equal to or less than ±20% of an average value, so that sufficient mixing is achieved.

Also in the gas mixer 1A, the outer pipe 22, the inner pipe 21, and the guide pipe 28 are formed in a polygonal tube shape. However, even when these components are formed in a circular tube shape, the same advantageous effects as those in the above-described first embodiment can be obtained. The catalyst 9 and the baffle plate 34 may be omitted.

Although the present invention has been fully described in connection with the embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1A, 1B . . . Gas mixer

11, 21 . . . Inner pipe

12, 22 . . . Outer pipe

13 . . . Storage space

14 . . . Supply pipe

18, 28 . . . Guide pipe

18c, 28c . . . Inflow port

19, 29 . . . Guide space

20, 30 . . . First introduction hole

31 . . . Second introduction hole

32 . . . Inflow portion

33 . . . Guide plate

34 . . . Baffle plate

36 . . . Through-hole

What is claimed is:

1. A gas mixer comprising:
an inner pipe through which a first gas passes;
an outer pipe covering an outer periphery of the inner pipe to form a storage space between the inner pipe and the outer pipe;
a supply pipe to supply a second gas to the storage space; and
a guide pipe disposed in an interior of the inner pipe and through which at least the first gas passes, wherein
the inner pipe is formed with a plurality of first introduction holes to introduce the second gas stored in the storage space to a guide space defined between the guide pipe and the inner pipe.

2. The gas mixer as claimed in claim 1, wherein the inner pipe has a passage area increasing toward a downstream side.

3. The gas mixer as claimed in claim 1, wherein the guide pipe has an upstream end formed with an inflow port into which the first gas flows.

4. The gas mixer as claimed in claim 1, wherein an inflow portion configured to allow the first gas to flow to the guide space is formed between the inner pipe and an upstream end of the guide pipe, and the inner pipe is formed with a plurality of second introduction holes to introduce the second gas into an interior of the guide pipe.

5. The gas mixer as claimed in claim 4, wherein each of the second introduction holes is formed in a nozzle and in the form of an elongated passage directed toward an inflow port of the guide pipe.

6. The gas mixer as claimed in claim 4, further comprising a guide plate extending along a flow direction of the first gas and configured to support the guide pipe on the inner pipe.

7. The gas mixer as claimed in claim 4, wherein each of the first introduction holes is formed in a nozzle and in the form of an elongated passage directed toward a downstream side in an inwardly oblique direction.

8. The gas mixer as claimed in claim 1, wherein a gap between an upstream end of the guide space and the inner pipe is closed.

9. The gas mixer as claimed in claim 8, wherein a downstream end of the guide space has an opening area which allows the second gas to flow out at a speed close to that of the first gas.

10. The gas mixer as claimed in claim 1, wherein a baffle plate having multiple through-holes is disposed at a downstream portion of the inner pipe.
